(19) United States
(12) Patent Application Publication
(10) Pub. No.: US 2015/0261314 A1
(43) Pub. Date: Sep. 17, 2015

(54) DISPLAYING CONTENT VIA POINT OF SALE COMPUTERS

(71) Applicant: TOSHIBA GLOBAL COMMERCE SOLUTIONS HOLDINGS CORPORATION, Tokyo (JP)

(72) Inventors: Dean Frederick HERRING, Youngsville, NC (US); Brad Matthew JOHNSON, Raleigh, NC (US); Jeffrey John SMITH, Raleigh, NC (US); Seth Thomas TEEPLES, Cary, NC (US)

(73) Assignee: TOSHIBA GLOBAL COMMERCE SOLUTIONS HOLDINGS CORPORATION, Tokyo (JP)

(21) Appl. No.: 14/212,760

(22) Filed: Mar. 14, 2014

(51) Int. Cl. G06F 3/03; G06Q 20/20

(52) U.S. Cl. CPC G06F 3/03; G06Q 20/20

(57) ABSTRACT

System, method, and computer program product for performing an operation, the operation comprising operating a tablet in a work mode when the tablet is oriented according to a first orientation, operating the tablet in an alternate mode when the tablet is oriented according to a second orientation, and outputting a content for display on the tablet based on a current operating mode of the tablet.

### BACKGROUND

Embodiments disclosed herein relate to the field of mobile computing devices. More specifically, embodiments disclosed herein relate to mobile computing devices that display content based on an operating mode of the computing device.

Tablet computers may be used by employees in retail stores to process sales transactions and perform other business-related tasks. To this end, the tablets may include peripheral devices such as card readers and barcode scanners to facilitate processing sales transactions, accessing product information and the like.

### SUMMARY

Embodiments disclosed herein provide at least a system, method, and computer program product for performing an operation, the operation comprising operating a tablet in a work mode when the tablet is oriented according to a first orientation, operating the tablet in an alternate mode when the tablet is oriented according to a second orientation, and outputting a content for display on the tablet based on a current operating mode of the tablet.

### BRIEF DESCRIPTION OF THE SEVERAL VIEWS OF THE DRAWINGS

FIGS. 1A-1B illustrate techniques to present customer content via point of sale computers, according to one embodiment.

FIG. 2 is a block diagram illustrating a system to present customer content via point of sale computers, according to one embodiment.

FIG. 3 is a flow chart illustrating a method to present customer content via point of sale computers, according to one embodiment.

FIG. 4 is a flow chart illustrating a method to operate a computer in a work mode, according to one embodiment.

FIG. 5 is a flow chart illustrating a method to operate a computer in an alternate mode, according to one embodiment.

FIG. 6 is a flow chart illustrating a method to output content on a tablet based on a current operating mode of the tablet, according to one embodiment.

### DETAILED DESCRIPTION

Employees (also referred to as store associates, or SAs) in a retail store often use a tablet computer (or other similar mobile devices) in order to perform their duties. Typically, the tablet is attached to a strap the employees wear around their bodies, such that when the tablet is not in use, the tablet folds down and the screen portion of the tablet faces out and away from the employee. This configuration may present an opportunity to convey additional information to customers that are in the retail store. Embodiments disclosed herein provide computing devices that operate in at least two modes. When the SA is using the tablet, the tablet operates in a “work mode,” which displays content allowing the SA to perform business-related activities, including, without limitation, completing sales transactions, searching inventory, and the like. When the SA is not using the tablet, the tablet operates in an “alternate” mode, during which the tablet may display content which includes, without limitation, information or advertisements directed to customers in the retail store. In at least some embodiments, an orientation of the tablet controls the current operating mode of the tablet. For example, and without limitation, if the SA is holding the tablet or the tablet is substantially facing the SA, this orientation may cause the tablet to operate in the work mode. However, if the tablet is substantially facing outward from the SA, such as when the tablet is not being held by the SA and is supported by a strap connected to the tablet and worn by the SA, this orientation may cause the tablet to operate in the alternate mode.

As used herein, the term “work mode” refers to operating a tablet or other mobile computing device for business-related purposes, including, without limitation, accessing applications to perform point of sale customer transactions, check inventory, order status, and the like. Generally, any business application can be executed and displayed on the tablet screen while the tablet is in the work mode. As used herein, the term “alternate mode” refers to operating a tablet to convey information to one or more people in the retail store, whether or not any specific people are present. The information conveyed in the alternate mode includes, without limitation, advertisements, informational notices, merchandise options, SA availability, SA expertise, hospitality notices, and the like. Generally, any information that a business may convey to a customer in the store may be displayed on the tablet when the tablet is operating in the alternate mode. The content displayed while the tablet is in the alternate mode may also include relevant information for store employees, such as an indication that a customer needs help in a specific department. However, employee content displayed in the alternate mode may exclude traditionally business-related content such as the point of sale application, inventory applications, and the like.

Although a tablet computer is used as a reference example, embodiments of the disclosure apply equally to all mobile computing devices, and any reference to a tablet computer should not be considered limiting of the disclosure.

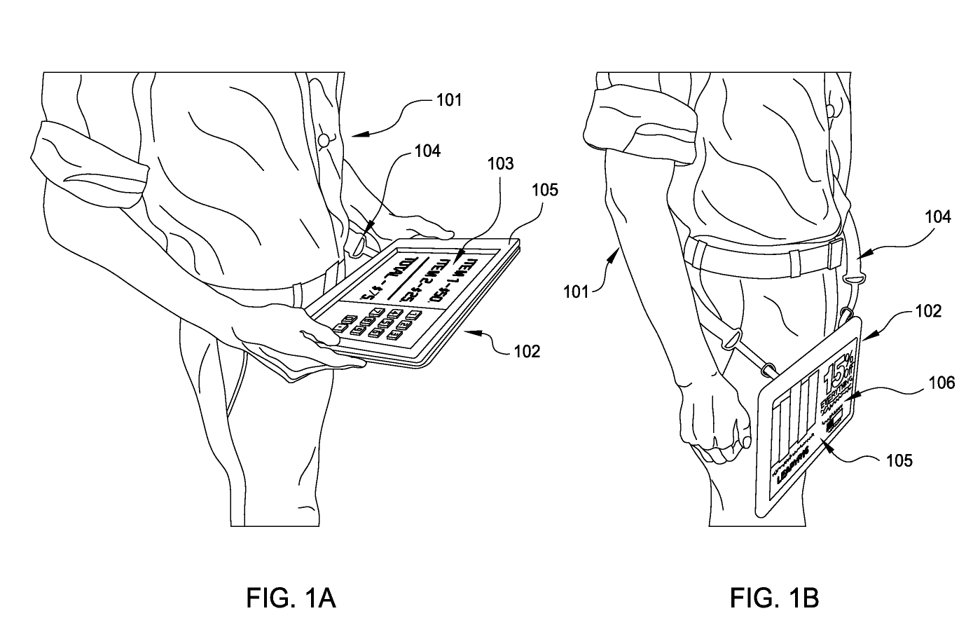

FIG. 1A illustrates techniques to present customer content via point of sale computers, according to one embodiment. As shown, a retail store associate (SA) 101 is holding a tablet 102 in a manner such that the tablet 102 is substantially facing the SA 101. Based on this orientation, the tablet 102 operates in a “work mode,” which allows the SA 101 to access one or more business applications. As shown, therefore, the tablet 102 displays a point-of-sale (POS) application 103 on a display 105 of the tablet 102, in order to allow the SA 101 to complete a POS transaction with a customer (not pictured). An accelerometer (not pictured) in the tablet 102 may sense that the orientation of the tablet 102 is such that it is facing the SA 101, which causes the tablet 102 to operate in the work mode. Additionally and/or alternatively, the tablet 102 may operate in work mode by detecting that the SA 101 is holding the tablet, or that the strap 104 is not supporting the weight of the tablet. While in work mode, the SA 101 may temporarily stop using (or holding) the tablet 102. In response, the tablet 102 may temporarily display a notification on the display 105 indicating, for example, that the SA 101 is busy helping the customer. If, however, the SA 101 does not resume using the POS application 103 after a predefined time threshold elapses, the tablet 102 may transition to an “alternate mode” in order to display additional information or advertisements to customers. More generally, and as described in further detail below, if the SA 101 is not using the tablet 102, the tablet 102 may operate in the alternate mode to provide context-based information and advertisements to customers.

FIG. 1B illustrates techniques to present customer content via point of sale computers, according to one embodiment. As shown, the tablet 102 is not being held by the SA 101, but instead is supported by the strap 104, and is facing away from the SA 101. Because the tablet 102 is facing away from the SA 101, the tablet 102 has a different orientation than the orientation when the SA 101 is using the tablet. The accelerometer of the tablet may detect this orientation, and in response, transition the tablet 102 to the alternate mode in order to display customer content. The tablet 102 may also transition to the alternate mode by detecting (via one or more sensors, not pictured) that the user is no longer gripping the tablet 102. Still further, the tablet 102 may transition to the alternate mode by determining, via one or more sensors, that the strap 104 is supporting the weight of the tablet 102. The tablet 102 may also transition to the alternate mode based on voice commands or voice recognition of a sales associate (having a known voice on file) or a customer (having an unknown voice). For example, the SA 101 may speak a voice command ordering the tablet 102 to flash a particular advertisement to a customer. If, for example, the customer is with children, the SA 101 may issue a voice command to direct the graphical portion of the screen to display an advertisement better suited for children, such as for a special in the toy department.

As shown in FIG. 1B, the tablet 102, operating in alternate mode, now outputs a store promotion 106 on the display 105. The store promotion 106 may generally be any type of content, including, without limitation, an advertisement, product promotion, notification, and the like. The content outputted on the display 105 while the tablet is in alternate mode may be based on one or more additional factors, including, without limitation, the location of the tablet 102 (and/or the SA 101) in the retail store, the presence and location of a customer in the retail store, the relationship between the locations of the customer and the tablet/SA, and a user profile of the SA 101. For example, if a user profile entry of the SA 101 indicates that he is an expert in paint the tablet 102 may display a message such as “I'm your paint expert, please ask me any question!” The tablet 102 may further reference a store layout in order to determine that the SA 101 is located in the paint department before displaying the message indicating be is a paint expert. As another example, if the SA 101 is stationed in the lumber department, the tablet 102 may display an advertisement for a specific type of wood that is currently on sale. If a proximity sensor (not shown) of the tablet 102 detects an approaching customer, the tablet 102 may display a message that says “Welcome! How can I help you?” If the proximity sensor detects a customer near the SA 101 for a predefined duration of time, the tablet 102 may determine that the SA 101 is helping the customer, and may display a message stating “Helping another customer, please wait for assistance.” If no customers are located near the SA 101, or a nearby customer is walking away from the SA 101, the tablet 102 may display a message indicating that the SA 101 is generally available to help customers. In addition, “mobile shoppers” may access mobile applications offered by the retail store. When these mobile shoppers are identified in the store and near the SA 101, the tablet 102 may display a personalized notification, such as “Welcome back Joan!”

Additionally, while in the alternate mode, the tablet 102 may detect the eye gaze of a customer using cameras or one or more sensors. If the tablet 102 determines that the customer is gazing at the tablet for a programmable threshold amount of time (for example, three seconds), the tablet 102 may customize the output for that person. For example, the tablet 102 may determine, by analyzing captured image data, that the customer is carrying a specific product that he or she intends to purchase, the tablet 101 may display advertisements for peripherals/accessories related to that product that the customer may be interested in purchasing. More generally, if the tablet 102 determines that the customer is gazing at the tablet for more than the threshold amount of time, the tablet 102 may output different slides relating to the content being displayed when the tablet 102 detects the customer's gaze.

In some embodiments, the tablet 102 may be placed in a dock (not pictured). For example, the dock may provide battery power charging for the tablet 102, or may hold the tablet 102 while employees change shifts. In such embodiments, the tablet 102 may sense that it is in the dock, determine its location in the store, its location relative to the store layout, and its location relative to a service associate and/or customer in order to display alternate mode content. For example, if the tablet 102 identifies an employee using voice recognition technology as the employee approaches the tablet 102, the tablet 102 may display a message indicating “Welcome to your shift!” If the tablet 102 identifies an approaching customer, the docket tablet 102 may display a message welcoming the customer to that section of the store.

In at least some embodiments, the tablet 102 may be controlled by a remote server (not pictured) having situational awareness of the entire store to cause the tablet 102 to display a relevant message. For example, if there is a spill in the store, the tablet 102 may display a message instructing customers to avoid the aisle where the spill occurred, or directing employees to clean up the spill. In a security-related embodiment, the tablet 102 may display a pair of human eyes, in order to encourage customers to remain honest while being “watched.” If security personnel detect suspicious activity around the SA 101, the security personnel may commandeer the tablet in order to cause the tablet to display the eyes or other messages in order to deter theft.

Generally, embodiments disclosed herein may use any technique to identify the location of the tablet 102, the SA 101, and the presence and location of any customers in the retail store. For example, wireless signals emitted from the tablet 102 may be triangulated in order to determine a precise location of the tablet 102. Similarly, a location of the SA 101 and a customer may be used by triangulating wireless signals of a mobile device they may possess. The presence of the SA 101 and a customer may be determined by analyzing video captured by in-store video cameras, detecting radio frequency identification (RFID) tags, and detecting wireless signals of mobile devices carried by the SA 101 or the customer. Additionally, one or more camera (not pictured) on the tablet may detect customers and/or the SA 101. For example, a rear-facing camera may detect customers when the tablet is in work mode, while a front-facing camera may detect customers when the tablet is in the alternate mode.

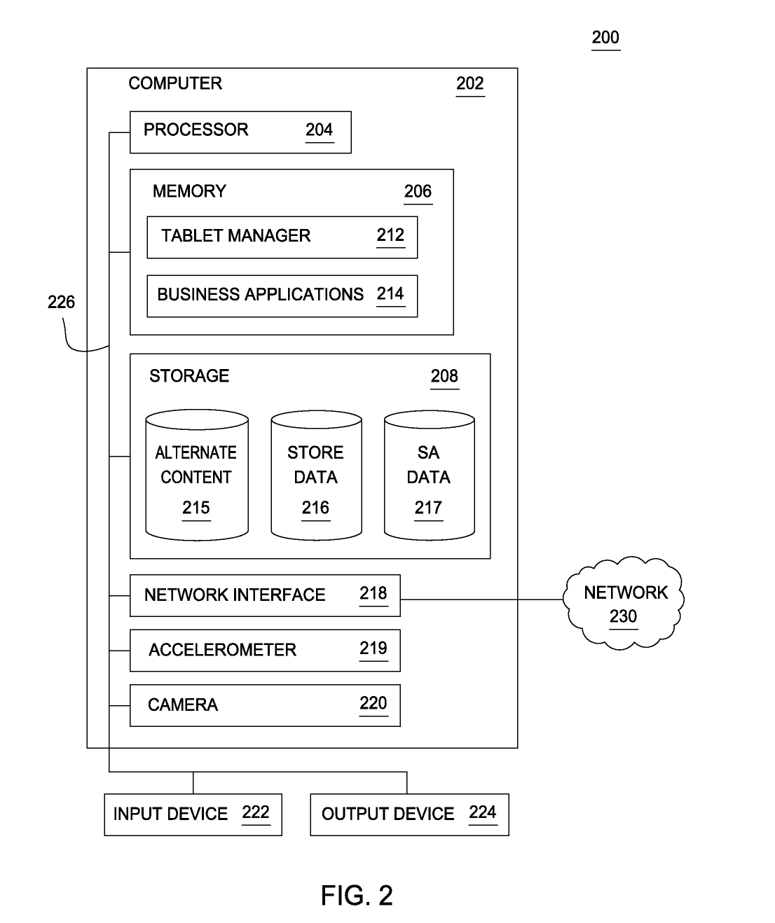

FIG. 2 is a block diagram illustrating a system 200 to present customer content via point of sale computers, according to one embodiment. The networked system 200 includes a tablet computer 202. In other embodiments, the tablet 202 is a mobile computing device with capabilities similar to a tablet computer, such as a smartphone. The tablet 202 may also be connected to other computers via a network 230. In general, the network 230 may be a telecommunications network and/or a wide area network (WAN). In a particular embodiment, the network 230 is the Internet.

The tablet 202 generally includes a processor 204 connected via a bus 220 to a memory 206, a network interface device 218, a storage 208, an input device 222, and an output device 224. The tablet 202 is generally under the control of an operating system (not shown). Examples of operating systems include the UNIX operating system, versions of the Microsoft Windows operating system, and distributions of the Linux operating system. (UNIX is a registered trademark of The Open Group in the United States and other countries. Microsoft and Windows are trademarks of Microsoft Corporation in the United States, other countries, or both. Linux is a registered trademark of Linus Torvalds in the United States, other countries, or both.) More generally, any operating system supporting the functions disclosed herein may be used. The processor 204 is included to be representative of a single CPU, multiple CPUs, a single CPU having multiple processing cores, and the like. The network interface device 218 may be any type of network communications device allowing the tablet 202 to communicate with other computers via the network 230.

The storage 208 may be a persistent storage device. Although the storage 208 is shown as a single unit, the storage 208 may be a combination of fixed and/or removable storage devices, such as fixed disc drives, solid state drives, SAN storage, NAS storage, removable memory cards or optical storage. The memory 206 and the storage 208 may be part of one virtual address space spanning multiple primary and secondary storage devices.

The input device 222 may be any device for providing input to the tablet 202. For example, a keyboard and/or a mouse may be used. The output device 224 may be any device for providing output to a user of the tablet 202. For example, the output device 224 may be any conventional display screen or set of speakers. Although shown separately from the input device 222, the output device 224 and input device 222 may be combined. For example, a display screen with an integrated touch-screen may be used. The camera 220 may comprise one or more different cameras configured to capture image or video data. The accelerometer 219 measures proper acceleration, and is used to ensure that images on a display screen are always displayed upright in any given tablet orientation (and therefore readable to an observer).

As shown, the memory 206 contains a tablet manager 212, which is configured to control different modes of operation of the tablet 202. For example, the tablet manager 212 may allow the tablet 202 to transition between a work mode and an alternate mode. While in the work mode, the tablet 202 executes and displays one or more of the business applications 214. While in the alternate mode, the tablet 202 may display one or more items of content from the alternate content 215. The tablet manager 212 may transition the tablet 202 between different modes by detecting a switch in orientation from the accelerometer 219, by determining through one or more touch sensors (not pictured) that a sales associate is holding the tablet 202, or that the tablet 202 is no longer being supported by a strap (not pictured) worn by a user. The tablet manager 212 may select items of content from the alternate content 215 to display in alternate mode based on one or more of a location of the tablet 202 in a retail store, a location of the sales associate in the retail store, a location of a customer in the retail store, one or more items of data in the SA data 217, and a relationship between the location of a sales associate and a location of the customer in the retail store. The memory 206 also includes the business applications 214, which includes a plurality of different business applications, such as a point-of-sale transaction application, an inventory application, a customer service application, and the like. Generally, the business applications 214 may include any business-related application.

As shown, the storage 208 includes the alternate content 215, the store data 216, and the SA data 217. The alternate content 215 includes, without limitation, messages, greetings, advertisements, photos, videos, and any other content that may be displayed in a retail store. In at least some embodiments, the alternate content 215 may also be stored in remote locations and accessed via the network 230. Additionally, the tablet manager 212 may dynamically generate content to output on the display of the tablet 202. For example, the tablet manager 212 may generate a notification based on one or more of the location of the tablet 202, a location of a customer in the retail store, one or more items in the store data 216, a location of a sales associate in the retail store, and a relationship between the two or more of the locations of the computer, the customer, and the sales associate. The store data 216 includes, without limitation, a layout of one or more retail stores, department location and information, product placement and information, and the like. The SA data 217 includes employee profile data, including, without limitation, job duties, areas of expertise, and the like.

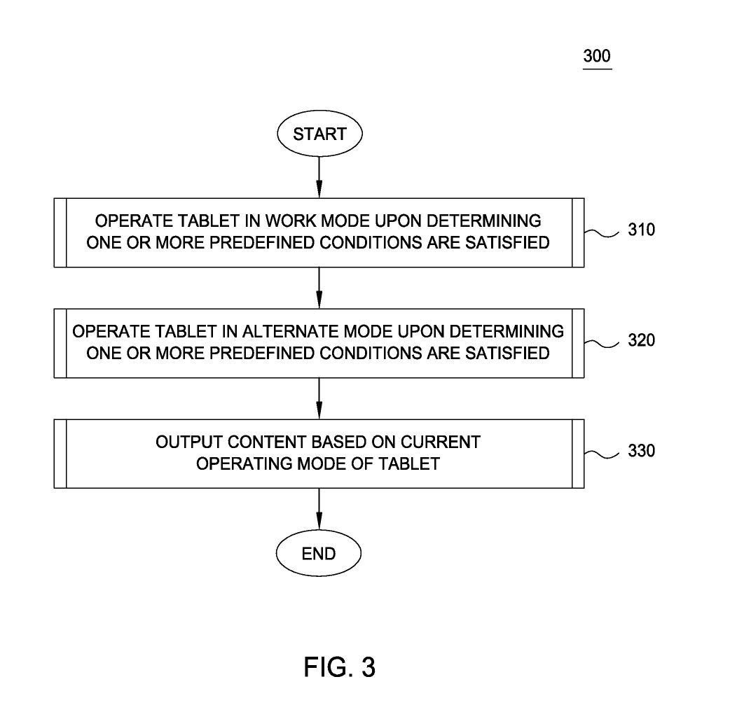

FIG. 3 is a flow chart illustrating a method 300 to present customer content via point of sale computers, according to one embodiment. The steps of the method 300 provide a computer, such as a tablet computer, that operates in at least a work mode and an alternate mode. When operating in the work mode, a sales associate may access one or more different business applications 114 on the tablet in order to carry out work-related duties, such as performing sales transactions with customers. When the tablet is in the alternate mode, the outward-facing tablet may display advertisements, notifications, and other messages to enhance a customer's experience in a retail store. In at least some embodiments, the tablet manager 212 performs the steps of the method 300.

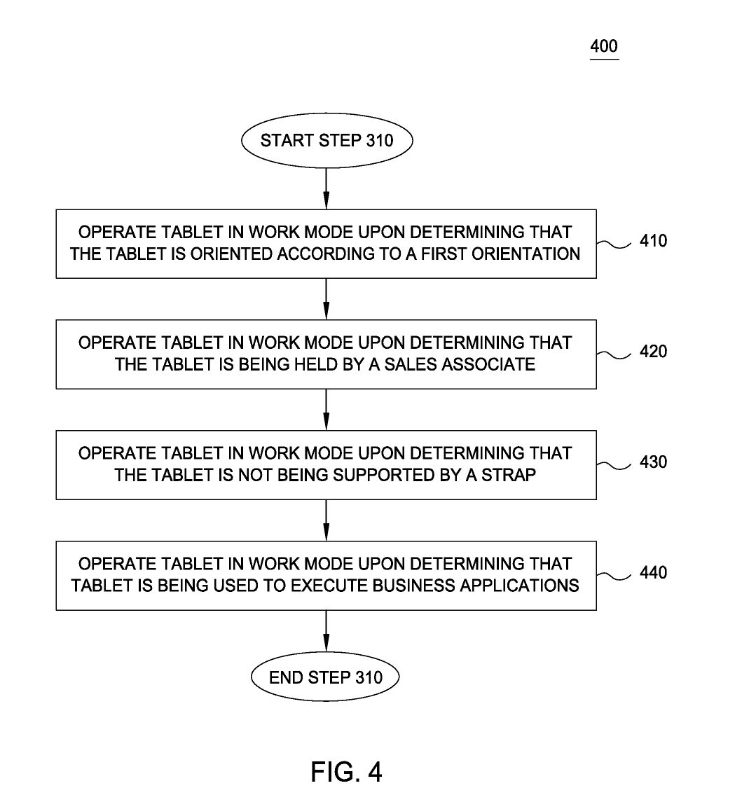

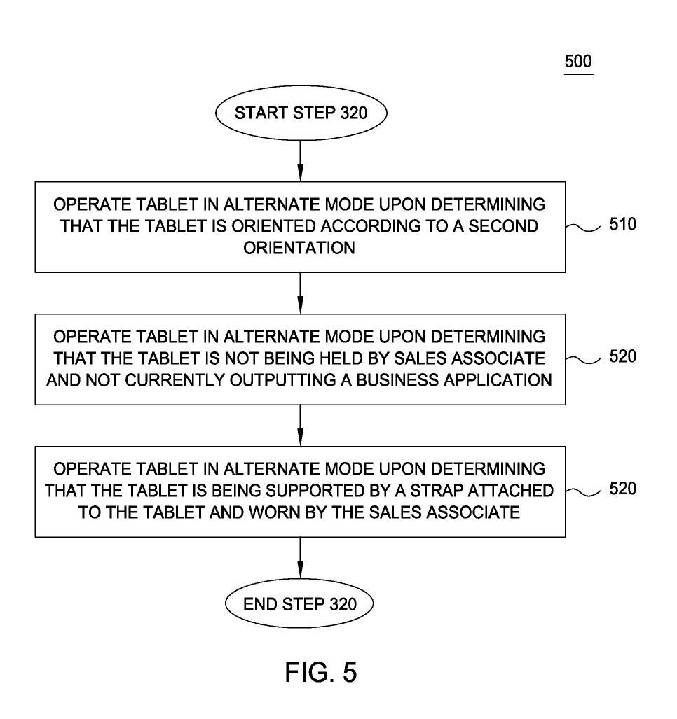

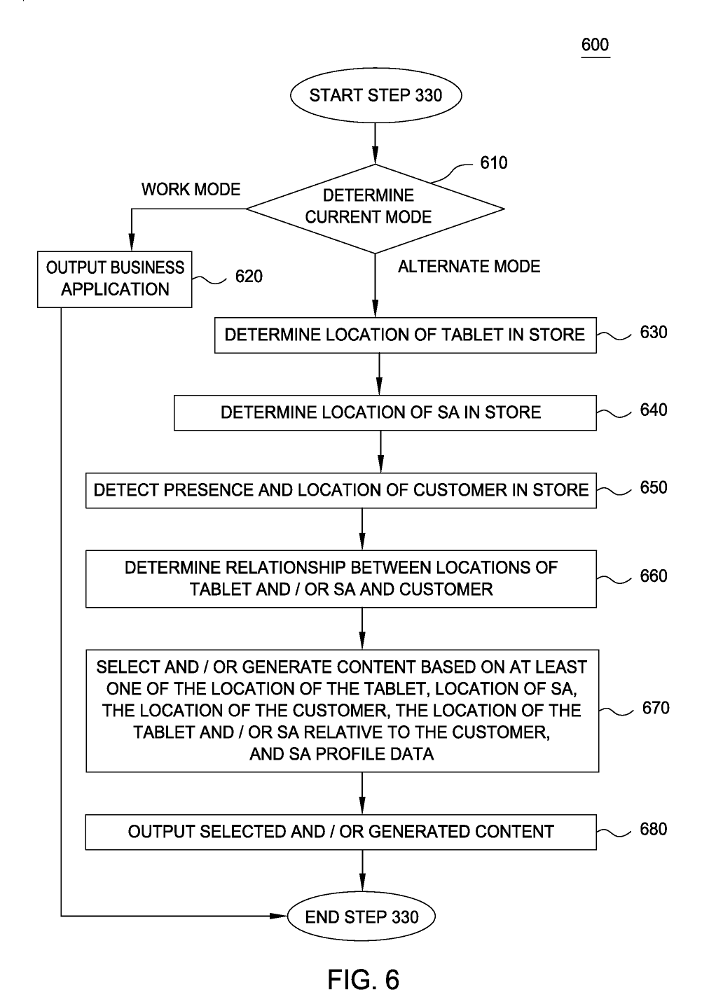

As shown, the method 300 begins at step 310, where the tablet manager 212 operates the tablet in a work mode upon determining that one or more predefined conditions are satisfied. Generally, the tablet manager 212 operates the tablet in the work mode whenever an employee is using the tablet such that the screen of the tablet is not outward facing, for example, to access one or more of the business applications 114. Exemplary conditions that cause the tablet manager 212 to operate the tablet in the work mode are described in greater detail with reference to FIG. 4. At step 320, the tablet manager 212 operates the tablet in the alternate mode upon determining one or more predefined conditions are satisfied. Generally, the tablet manager 212 operates the tablet in the alternate mode upon detecting an opportunity to convey information to customers through the outward-facing screen of the tablet. Exemplary conditions that cause the tablet manager 212 to operate the tablet in the alternate mode are described in greater detail with reference to FIG. 5. At step 330, the tablet manager 212 outputs content on the tablet based on a current operating mode of the tablet. For example, the tablet manager 212 may display one or more business applications 114 if the tablet is in work mode. If the tablet is in the alternate mode, the tablet manager 212 may display targeted, context-aware content on the tablet, such as product advertisements, customer notices, and the like. Example content displayed on the tablet is discussed in greater detail with reference to FIG. 6.

FIG. 4 is a flow chart illustrating a method 400 corresponding to step 310 to operate a computer in a work mode, according to one embodiment. Generally, the steps of the method 400 provide conditions that, when identified by the tablet manager 212, cause the tablet manager 212 to operate a tablet computer in the work mode. Although the method 400 is depicted as a flow chart, the tablet manager 212 may execute one, several, or all of the steps of the method 400 in order to operate the tablet into the work mode.

At step 410, the tablet manager 212 may cause the tablet to operate in work mode upon determining that the tablet is oriented according to a first orientation. Generally, the first orientation reflects an orientation of the tablet when the tablet is being used by a sales associate in order to access one or more applications on the tablet. For example, the sales associate may hold the tablet or place the tablet on a stand (or other supporting surface) in order to access applications, such as the business applications 114. When used by the sales associate, the tablet may be substantially facing the sales associate. When the tablet manager 212 detects this orientation, the tablet manager 212 may operate the tablet in work mode. At step 420, the tablet manager 212 operates the tablet in work mode upon determining that the tablet is being held by a sales associate. For example, the tablet may have touch sensors that communicate to the tablet manager 212 that the user is grasping or otherwise touching the tablet. Upon detecting such a condition, the tablet manager 212 may cause the tablet to operate in the work mode. At step 430, the tablet manager 212 may cause the tablet to operate in work mode upon determining that the tablet is not being supported by a strap connected to the tablet and worn by the sales associate. For example, the tablet may have a sensor (such as a scale) that may determine whether the strap is supporting the weight of the tablet. If the strap is not supporting the weight of the tablet, then the tablet manager 212 may infer that the sales associate is using the tablet, and that the tablet should be transitioned to work mode (if not already in work mode).

At step 440, the tablet manager 212 may cause the tablet to operate the tablet to operate in work mode upon determining that the tablet is being used to execute business applications. For example, if a sales associate is using the tablet to execute a point-of-sale (POS) application, of the business applications 114, the tablet manager 212 may cause the work mode to persist even if the sales associate temporarily lets go of the tablet (and triggers conditions that would otherwise cause the tablet manager 212 to operate the tablet in the alternate mode). In some embodiments, the tablet manager 212 may operate the tablet in the work mode for a programmable threshold amount of time before switching the tablet to the alternate mode. Therefore, if the sales associate dropped the tablet during a POS transaction, causing the orientation to switch and causing the strap to support the weight of the tablet, the tablet manager 212 may not immediately transition the tablet to the alternate mode, as the POS application is currently open and being used to process a transaction. However, if the predefined time threshold elapses (for example, 2 minutes), the tablet manager 212 may then transition the tablet to the alternate mode.

FIG. 5 is a flow chart illustrating a method 500 corresponding to step 320 to operate a computer in an alternate mode, according to one embodiment. Generally, the steps of the method 500 provide conditions that, when identified by the tablet manager 212, cause the tablet manager 212 to operate a tablet computer in the alternate mode. Although the method 500 is depicted as a flow chart, the tablet manager 212 may execute one, several, or all of the steps of the method 500 in order to operate the tablet into the alternate mode.

At step 510, the tablet manager 212 may cause the tablet to operate in the alternate mode upon determining that the tablet is oriented according to a second orientation. Generally, the second orientation reflects a substantially outward-facing orientation from the perspective of the sales associate, such as when the tablet is supported by a strap worn by the sales associate. In the second orientation, the screen of the tablet faces outward, such that customers in the retail store may read messages displayed on the screen. At step 520, the tablet manager 212 may cause the tablet to operate in the alternate mode upon determining that the tablet is not being held by a sales associate and that the tablet is not currently outputting a business application, such as one of the business applications 114. For example, the sales associate may place the tablet on a table or other supporting surface. If the tablet is not executing one of the business applications, the tablet manager 212 may transition the tablet into the alternate mode. In some embodiments, the tablet manager 212 may transition the tablet to the alternate mode when the tablet is not being held by the store associate and a business application is being outputted if the sales associate does not use the business application for a programmable idle time threshold. For example, if the tablet is executing the POS application and the sales associate sets the tablet on a table, the tablet manager 212 may transition the tablet to the alternate mode if the SA does not use the tablet for the idle time threshold (such as 45 seconds).

At step 530, the tablet manager 212 may cause the tablet to operate in the alternate mode upon determining that the tablet is being supported by a strap attached to the tablet and being worn by the sales associate. Generally speaking, the tablet manager 212 may leverage the outward facing orientation of the tablet when supported by the strap in order to display one or more messages to customers in the retail store. In at least some embodiments, if the tablet is outputting one of the business applications 114 when the tablet is being supported by the strap, the tablet manager 212 may wait for a predefined time threshold to elapse prior to transitioning the tablet to the alternate mode. Generally, the tablet manager 212 may leverage any number of conditions and heuristics to transition the tablet from one mode to another, or to persist a current mode of operation. The example conditions and heuristics described herein should therefore not be considered limiting of the disclosure.

FIG. 6 is a flow chart illustrating a method 600 corresponding to step 330 to output content on a computer based on a current operating mode, according to one embodiment. In some embodiments, the tablet manager 212 performs the steps of the method 600. Although depicted as a flow chart, the tablet manager 212 may perform one, several, or all of the steps of the method 600 in order to output content based on the current operating mode of the tablet.

At step 610, the tablet manager 212 determines the tablet's current mode of operation. If the tablet is in work mode, the tablet manager 212 proceeds to step 620. If the tablet is in the alternate mode, the tablet manager 212 proceeds to step 630. At step 620, the tablet manager 212 may output a business application upon determining that the tablet is the work mode. For example, if the sales associate opens a point-of-sale (POS) application, the tablet manager 212 may output the POS application, and forego displaying targeted advertisements or messages that may be displayed in the alternate mode. In some embodiments, the tablet manager 212 may output a “Busy” notification to customers when the tablet is being used, but not held by, an employee executing a business application 114.

If the tablet is in the alternate mode, at step 630, the tablet manager 212 determines the location of the tablet in the retail store. Generally, the tablet manager 212 may use any feasible method to determine the location of the tablet, including, without limitation, triangulating wireless signals, Bluetooth® communications, radio frequency identification (RFID), near-field communication (NFC), processing in-store camera data to detect the tablet, and the like. At step 640, the tablet manager 212 determines the store location of the sales associate (SA) operating the tablet. In some embodiments, the tablet manager 212 may infer that the SA is substantially near the tablet. In other embodiments, the tablet manager 212 may determine the SA's location separately from the location of the tablet. For example, the tablet manager 212 may analyze video data of in-store cameras to detect the SA. Additionally, the tablet manager 212 may perform communications with a different mobile device carried by the SA to determine the SA's location. As with the tablet, the tablet manager 212 may also use wireless signal triangulation, Bluetooth, RFID, or NFC to detect the other mobile device carried by the SA, and therefore determine the SA's location.

At step 650, the tablet manager 212 may detect the presence of a customer and determine the customer's location in the store. The tablet manager 212 may detect the presence of a customer by any feasible method, including analyzing data from in-store video cameras, detecting signals emitted by a mobile device of the customer, proximity sensors on the tablet, or analyzing data from the camera 220 of the tablet when the tablet is substantially facing outward from the SA. By leveraging these techniques to detect the customer's presence, as with the tablet and other mobile devices, the tablet manager 212 may also determine the customer's location. For example, if an in-store video camera focusing on the store entrance detects a customer, the tablet manager 212 may cross-reference the store layout in the store data 216 to determine the customer's location based on what area of the store the video camera is configured to monitor. In some embodiments, if the tablet manager 212 does not detect any customers proximate to the tablet, the tablet manager 212 may provide general informational notices or advertisements, or may not output any information in the alternate mode. At step 660, the tablet manager 212 determines a relationship between the location of the tablet (and/or the SA) and the customer. Generally, the tablet manager 212 may leverage the location of the tablet in relation to potential viewers, such as customers, in order to influence what content is displayed, and how it is displayed. For example, if a customer is beyond a specified distance from the tablet, the tablet manager 212 may display text at a larger size, such that the customer is more likely to be able to read the text. In addition, the tablet manager 212 may change the content displayed based on whether the customer is within or beyond one of a plurality of distance thresholds. Additionally, if two tablets are in proximity to each other while in the alternate mode, the instances of the tablet manager 212 executing on each respective tablet may communicate in order to ensure that different or complimentary content are displayed on each device.

At step 670, the tablet manager 212 may select content from the alternate content 216 or generate new content based on at least one of the location of the tablet, the location of SA, the location of the customer, the location of the tablet and/or the SA relative to the location of the customer, and profile data of the SA in the SA data 217. For example, if the SA is available and a customer is walking towards the SA, the tablet manager 212 may retrieve content from the SA data 217 that says “Hello, can I help you with your purchase?” If the customer is using a loyalty application for the store on a mobile phone, the tablet manager 212 could modify the content from the SA data 217 to include the customer's name, or create a new greeting to welcome the customer by name. Generally, the tablet manager 212 may generate or retrieve any relevant content at step 670. For example, if the SA data 217 indicates that the SA wearing the tablet is an expert in televisions, and the tablet manager 212 determines that the SA/tablet are in the television department, the content may be a message indicating “Ask me your toughest TV questions!” If, however, the same SA is not a speaker expert, and the SA/tablet are located near a customer in the speaker department, the tablet manager 212 may select a speaker advertisement from the alternate data 216. If the SA is located near the entrance of the store, the tablet manager 212 may display content that reads “Welcome to our store, please ask me about this week's specials!” whenever a customer walks in the entrance. Generally, the tablet manager 212 may output any type of advertisement, notification, or content on the tablet when in the alternate mode. For example, and without limitation, the tablet manager 212 may thank customers for their business, advertise sales for specific departments or products, act as a billboard, or encourage customers to approach the current SA to pay for the items they wish to purchase. At step 680, the tablet manager 212 may output the content selected and/or generated at step 670.

Advantageously, embodiments disclosed herein provide portable computers (such as tablets, phones, and the like) that can operate in two or more modes in a retail store. When in a work mode, the computer allows employees to perform work-related tasks on one or more business applications. When in an alternate mode, the computer may be used to display advertisements, promotions, specials, or any other informational content targeted to customers.

The descriptions of the various embodiments of the present disclosure have been presented for purposes of illustration, but are not intended to be exhaustive or limited to the embodiments disclosed herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications or related data available in the cloud. For example, the tablet manager 112 could execute on a computing system in the cloud, and push notifications to one or more local tablets. In such a case, the tablet manager 112 could generate alternate mode content and store the generated content at a storage location in the cloud. Doing so allows a user to access this information from any computing system attached to a network connected to the cloud (e.g., the Internet).

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
operating a tablet in a work mode when the tablet is oriented according to a first orientation;
operating the tablet in an alternate mode when the tablet is oriented according to a second orientation; and
outputting a content for display on the tablet based on a current operating mode of the tablet.

2. The method of claim 1, further comprising:
operating the tablet in the work mode upon determining that the tablet is being held by a sales associate, wherein the content is readable to the sales associate when the tablet is oriented according to the first orientation.

3. The method of claim 1, further comprising:
operating the tablet in the alternate mode upon determining at least one of: (i) that the tablet is not being held by a sales associate and that the outputted content is not part of an application accessed by the associate; and (ii) that the tablet is being supported by a strap attached to the tablet and worn by the sales associate.

4. The method of claim 1, wherein the current operating mode is the work mode, wherein the content comprises at least one of: (i) a point of sale application, (ii) an inventory application, and (iii) a business application.

5. The method of claim 1, wherein the first and second orientations are defined by respective output values of an accelerometer of the tablet.

6. The method of claim 1, wherein the current operating mode is the alternate mode, wherein the content comprises at least one of: (i) a message and (ii) an advertisement directed to a customer in a retail store, wherein the content is readable by the customer when the tablet is oriented according to the second orientation.

7. The method of claim 6, further comprising:
determining, based on a wireless signal generated by the tablet, a location of the tablet in the retail store, wherein the content is further based on the location of the tablet.

8. The method of claim 7, further comprising:
determining a location of a customer in the retail store, wherein the content is further based on the location of the customer in the retail store, wherein the location of the customer is determined based on at least one of: (i) detecting the customer on a video captured by a camera in the retail store, (ii) detecting an radio-frequency identification (RFID) device of the customer, and (iii) determining a location of a mobile device of the customer.

9. The method of claim 8, further comprising:
identifying, based on a layout of the retail store, at least one of: (i) a store department and (ii) a product proximate to the location of at least one of: (a) the customer, and (b) the tablet, wherein the content is further based on the identified at least one store department and product.

10. The method of claim 1, wherein the content is further based on a profile of a sales associate operating the tablet, wherein the profile specifies at least one of: (i) a specialty, (ii) an expertise, (iii) a role, and (iv) a job description of the sales associate.

11. A system, comprising:
one or more computer processors; and
a memory containing a program, which when executed by the one or more computer processors, performs an operation, the operation comprising:
operating a tablet in a work mode when the tablet is oriented according to a first orientation;
operating a tablet in an alternate mode when the tablet is oriented according to a second orientation; and
outputting a content for display on the tablet based on a current operating mode of the tablet.

12. The system of claim 11, the operation further comprising:
operating the tablet in the work mode upon determining that the tablet is being held by a sales associate, wherein the content is readable to the sales associate when the tablet is oriented according to the first orientation

13. The system of claim 11, the operation further comprising:
operating the tablet in the alternate mode upon determining at least one of: (i) that the tablet is not being held by a sales associate and that the outputted content is not part of an application accessed by the associate; and (ii) that the tablet is being supported by a strap attached to the tablet and worn by the sales associate.

14. The system of claim 11, wherein the current operating mode is the work mode, wherein the content comprises at least one of: (i) a point of sale application, (ii) an inventory application, and (iii) a business application.

15. The system of claim 11, wherein the current operating mode is the alternate mode, wherein the content comprises at least one of: (i) a message and (ii) an advertisement directed to a customer in a retail store, wherein the content is readable by the customer when the tablet is oriented according to the second orientation.

16. A computer program product, comprising:
a computer-readable storage medium having computer-readable program code embodied therewith, the computer-readable program code comprising:
computer-readable program code configured to operate a tablet in a work mode when the tablet is oriented according to a first orientation;
computer-readable program code configured to operate the tablet in an alternate mode when the tablet is oriented according to a second orientation and
computer-readable program code configured to output a content for display on the tablet based on a current operating mode of the tablet.

17. The computer program product of claim 16, further comprising:
computer-readable program code configured to operate the tablet in the work mode upon determining that the tablet is being held by a sales associate, wherein the content is readable to the sales associate when the tablet is oriented according to the first orientation.

18. The computer program product of claim 16, further comprising:
computer-readable program code configured to operate the tablet in the alternate mode upon determining at least one of: (i) that the tablet is not being held by a sales associate and that the outputted content is not part of an application accessed by the associate; and (ii) that the tablet is being supported by a strap attached to the tablet and worn by the sales associate.

19. The computer program product of claim 16, wherein the current operating mode is the work mode, wherein the content comprises at least one of: (i) a point of sale application, (ii) an inventory application, and (iii) a business application.

20. The computer program product of claim 16, wherein the current operating mode is the alternate mode, wherein the content comprises at least one of: (i) a message and (ii) an advertisement directed to a customer in a retail store, wherein the content is readable by the customer when the tablet is oriented according to the second orientation.
